(19) United States
(12) Patent Application Publication
(10) Pub. No.: US 2026/0266584 A1
(43) Pub. Date: Sep. 10, 2026

(54) YAW CARDS FOR BALLISTIC TESTING

(71) Applicant: Hardwire, LLC, Pocomoke City, MD (US)

(72) Inventors: George C. TUNIS, III, Ocean City, MD (US); Benjamin John KREMER, Snow Hill, MD (US); Steven J. WINCKLER, Middle Grove, NY (US)

(21) Appl. No.: 19/561,280

(22) Filed: Mar. 9, 2026

Related U.S. Application Data
(60) Provisional application No. 63/768,525, filed on Mar. 7, 2025.

(51) Int. Cl. F41J 5/24; G01B 5/24; G06T 7/62; G06T 7/90

(52) U.S. Cl. CPC F41J 5/24; G01B 5/24; G06T 7/62; G06T 7/90; G06T 2207/20024

(57) ABSTRACT

Provided herein are yaw cards for ballistic testing having a witness layer and a shockwave-dissipating layer laminated to the witness layer.

### CROSS REFERENCE TO RELATED APPLICATIONS

This application claims benefit under 35 U.S.C. §119(e) of U.S. Provisional Application No. 63/768,525, filed on 7 Mar. 2025, entitled “Yaw Cards for Ballistic Testing,” the entirety of each of which is incorporated by reference herein.

### BACKGROUND

In ballistic testing, yaw refers to the angle between a bullet's axis and its line of flight. Even small yaw angles can affect penetration and armor test results.

Traditionally, yaw is measured by placing a thin yaw card (usually paper or light cardboard) in front of the target and examining the bullet hole. Generally, as shown in prior art FIGS. 1-3, the yaw card 100 is placed perpendicular to the bullet path, as close to the target as feasible, to produce a hole 101 that will ostensibly capture the bullet's orientation just before striking the armor (see FIGS. 1-3). A perfectly circular hole indicates zero yaw, whereas an elongated or oval hole implies the bullet was yawing (tilted) at impact. By measuring the major and minor axes of the oval perforation, testers can compute the yaw angle. Such measurements are important for confirming a compliant armor test. For example, ballistic testing standards often require yaw to be under about 5° for a valid armor test. Such measurement is sometimes performed, as shown in prior art FIG. 2, by placing a transparent film 200 printed with a nominal projectile diameter and then a series of circles 201 to indicate what the projected area is for various degrees of yaw.

Yaw cards are popular because they are simple and low-cost, and do not require complex instruments. They are usually made of a stiff paper or card material that a passing bullet or fragment will, hopefully, punch a clean hole through, thereby showing the projectile's profile at impact. The stiffness of the yaw card is important: higher stiffness generally allows the bullet to cut a cleaner outline of its cross-section rather than tearing the card raggedly (e.g., the ragged edges of the hole 101 in the yaw card 100 as shown in prior art FIGS. 1-3, which makes it difficult or impossible to read the result.

On the other hand, a yaw card that is too thick and/or stiff can slow and/or deflect the bullet, thereby negatively impacting the ballistic test. Based on those constraints, yaw cards are often made of standard cardstock or paper, including, for example, heavy photographic paper (about 8×8 inches).

Despite their popularity and utility, standard paper-only yaw cards have drawbacks. Fast projectiles produce a shockwave that can shred or tear the paper, especially around the hole edges. This “spring back and tearing of the hole edges” can distort the shape, making it hard to measure yaw accurately. In other words, the very evidence needed (a clean hole) is often destroyed by the bullet's shockwave or by the paper's inability to support the cutout. Standard yaw cards also only provide a single data point per shot and require careful realignment or replacement for each test. If the card rips or blows apart, the outline of the bullet profile is lost, defeating the purpose of the measurement.

Other solutions focus on highly complex, costly optical and/or video-based systems including arrays of high-speed cameras, sensors, strobe lighting systems, and customized software to measure yaw (and related parameters like spin or velocity). Such systems are expensive and risky. For example, such systems often include many components that are ballistically fragile, meaning spalling, misfires, fragmentation, and other common ballistic testing hazards have the potential to damage, destroy, and/or impede performance of the optical and/or video-based system. In addition, such systems often require specially trained, experienced operators to ensure proper calibration and use.

Other ballistic testing methodologies, such as traditional witness plates (e.g., thin metal or paper sheets behind armor) record penetration or fragment sprays but cannot record yaw angles in a measurable way.

### SUMMARY

Provided herein are yaw cards for ballistic testing having at least one witness layer and one or more shockwave-dissipating layers. That is, the layered yaw cards provided herein combine a penetrable sheet for recording bullet orientation with a shockwave-dissipating backing to prevent tearing. In this manner, the technology provided herein preserves the simplicity and low cost of a conventional yaw card while improving reliability and performance. This is achieved by laminating the witness layer (e.g., constructed of paper or cardstock such as photographic paper) with a shockwave-absorbing layer (e.g. constructed of a low-density foam or similar energy absorbing backing material) to prevent tearing.

Improvement on traditional yaw cards is thus achieved by hybridizing two known materials—e.g., paper and foam as shown and described herein—to exploit the benefits of both. The paper provides a smooth surface (witness layer) to mark the bullet's outline (also referred to interchangeably as a “projectile signature” or “witness hole”), and the foam gives structural support and shock absorption to the paper to prevent tearing or other destruction of the layered yaw card. The result is a more durable yaw card that can record the exact shape of the bullet's cross-section, even under the violent pressure of a passing supersonic round. The technique is very practical for precision yaw measurement applications such as, for example, ensuring a test bullet's yaw is under 3-5° as required by body armor standards.

Critically, as shown by the test results illustrated and described herein, the layered yaw cards presented herein do not have a measurable effect on the trajectory or velocity of the ballistic round being used for the test.

The layered yaw cards provided herein advantageously improve ballistic testing, including testing of ballistic armor such as, for example, body armor, armored helmets, and/or armor plates via improved precision and accuracy with respect to yaw measurement, resulting from ensuring that the evidence (hole shape) isn't destroyed by the ballistic round during the test.

In one aspect a layered yaw card for ballistic testing is provided. The layered yaw card includes a witness layer. The layered yaw card also includes a shockwave-dissipating layer laminated to the witness layer.

In some embodiments, the witness layer is constructed of one or more of paper, cardstock, cardboard, photographic paper, or combinations thereof. In some embodiments, the shockwave-dissipating layer is constructed of a foam. In some embodiments, the layered yaw card also includes a dot pattern printed on a visible surface of the witness layer. In some embodiments, the layered yaw card also includes a pattern of electrical circuits formed on or in at least one of the witness layer and/or the shockwave-dissipating layer. In some embodiments, the witness layer is colored for filterable high contrast relative to an image background, wherein an optical and/or video sensor is configured to capture optical and/or video data including both the witness layer and the image background.

In another aspect, a method for determining yaw of a ballistic projectile is provided. The method includes interposing the layered yaw card of claim 1 between a ballistic projectile and a target such that he ballistic projectile passes through the layered yaw card to form a witness hole in the witness layer. The method also includes measuring one of a diameter of the witness hole or both a major axis and minor axis of the witness hole. The method also includes determining, according to the measured diameter or major and minor axes, a yaw angle of the ballistic projectile.

In some embodiments, the method also includes measuring a maximum width of the witness hole and a distance from an edge of the witness hole to the center of the witness hole to determine both the yaw angle and an orientation of yaw of the ballistic projectile. In some embodiments, the step of measuring further comprises analyzing video and/or optical data captures including the witness hole. In some embodiments, the step of analyzing video and/or optical data captures includes performing one or more of an edge enhancement analysis of the video and/or optical data captures, a color filtration analysis of the video and/or optical data captures, a pixel counting of the video and/or data captures with respect to a pre-populated dense point cloud, or a combination thereof. In some embodiments, the witness layer is colored for filterable high contrast relative to an image background of the video and/or optical data captures to aid the color filtration analysis and/or the edge enhancement analysis.

### BRIEF DESCRIPTION OF THE DRAWINGS

FIG. 1 illustrates a yaw card having a plurality of ballistic signatures therein in accordance with the prior art.

FIG. 2 illustrates a process for evaluating yaw using a printed transparent film for comparison to ballistic signatures on a yaw card in accordance with the prior art.

FIG. 3 illustrates a back side of a conventional yaw card having a plurality of ballistic signatures therein in accordance with the prior art.

FIG. 4 illustrates a side view of a layered yaw card in accordance with various embodiments.

FIG. 5 illustrates a rear view of a layered yaw card prior to ballistic testing in accordance with various embodiments.

FIG. 6 illustrates a rear view of the layered yaw card of FIG. 5 after ballistic testing.

FIG. 7 illustrates a ballistic signature formed in a layered yaw card in accordance with various embodiments.

FIG. 8 illustrates a closeup view of the ballistic signature of FIG. 7.

FIG. 9A illustrates a ballistic range setup including a yaw card mount and a target in accordance with various embodiments.

FIG. 9B illustrates a ballistic range setup including a break screen positioned in front of a layered yaw card in accordance with various embodiments.

FIG. 10 illustrates a video analysis of a ballistic test using a layered yaw card in accordance with various embodiments.

FIG. 11 illustrates a comparison between ballistic signatures in a conventional, unsupported yaw card and a layered yaw card on a front strike face thereof.

FIG. 12 illustrates the comparison of the ballistic signatures in the conventional, unsupported yaw card and the layered yaw card of FIG. 11 on a back face thereof.

FIG. 13 illustrates a method for determining both yaw angle and yaw orientation from a ballistic signature formed in a layered yaw card in accordance with various embodiments.

FIG. 14 illustrates an orientation reference diagram used to measure projectile yaw direction relative to vertical datum in accordance with the prior art.

FIG. 15 illustrates an uprange ballistic signature formed on an uprange yaw card during an experimental test fire in accordance with various embodiments.

FIG. 16 illustrates a downrange ballistic signature formed on a downrange yaw card during the experimental test fire of FIG. 15 in accordance with various embodiments.

FIG. 17 illustrates a video analysis of a ballistic projectile of the experimental test fire of FIG. 15 observed immediately prior to impact with a target in accordance with various embodiments.

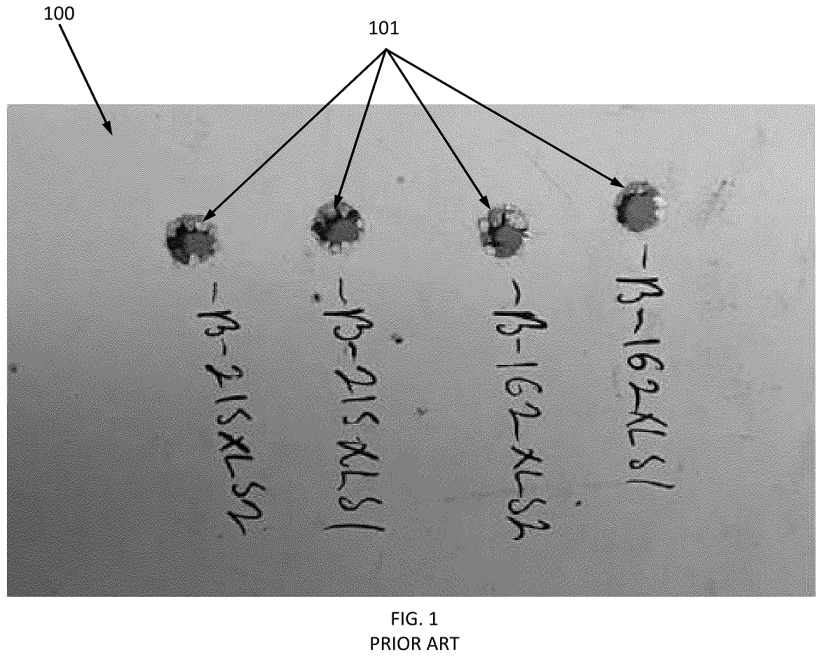

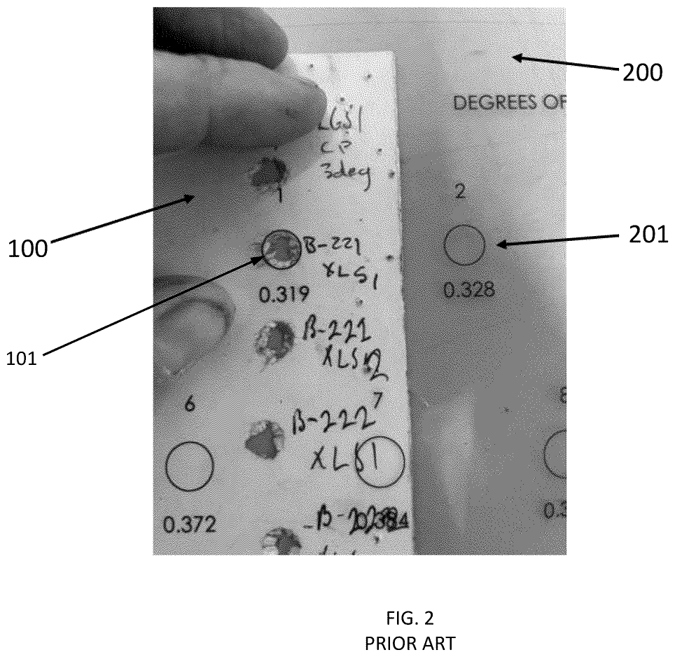

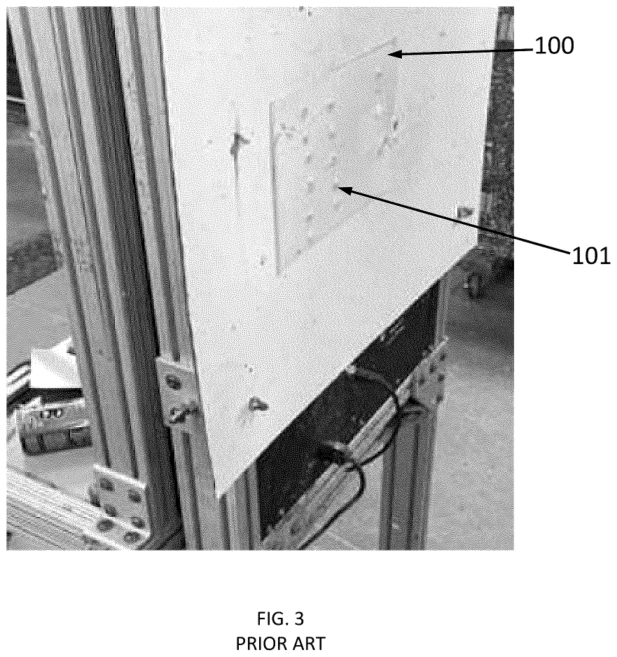

### DETAILED DESCRIPTION

### Layered Yaw Cards

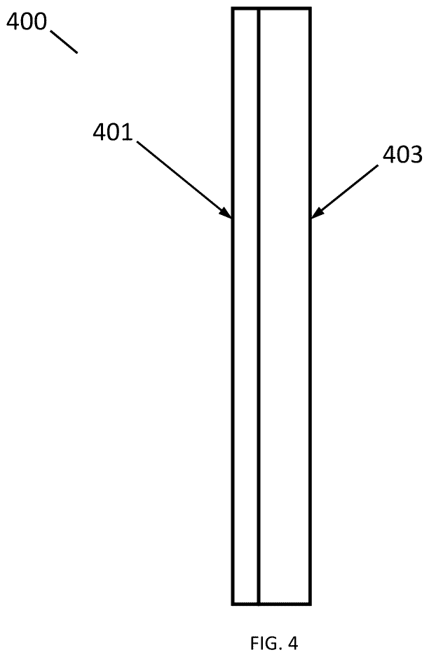

Provided herein are yaw cards for ballistic testing having at least one witness layer and one or more shockwave-dissipating layers. That is, the layered yaw cards provided herein combine a penetrable sheet for recording bullet orientation with a shockwave-dissipating backing to prevent tearing. In this manner, the technology provided herein preserves the simplicity and low cost of a conventional yaw card while improving reliability and performance. This is achieved, as best shown in FIG. 4, by providing a layered yaw card 400 having a witness layer 401 (e.g., constructed of paper or cardstock such as photographic paper) laminated over a shockwave-absorbing layer 403 (e.g. constructed of a low-density foam or similar energy absorbing backing material) to prevent tearing.

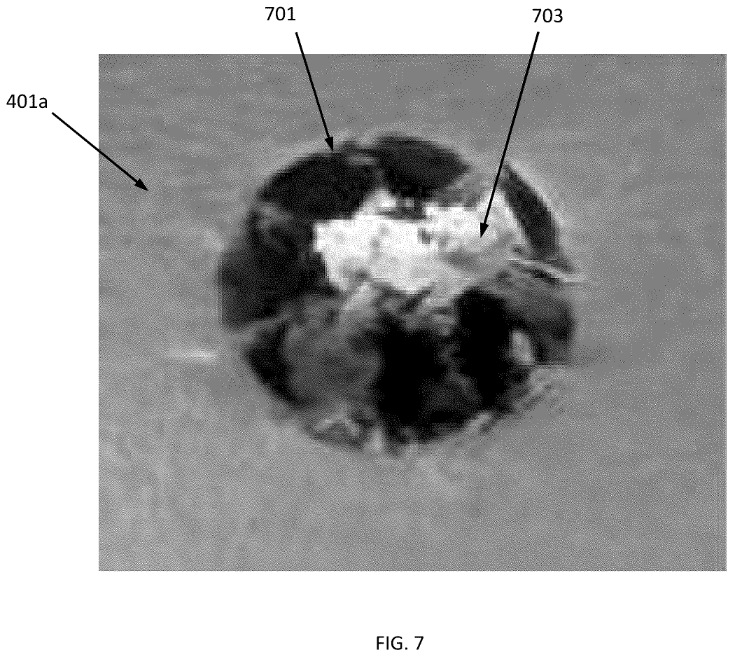

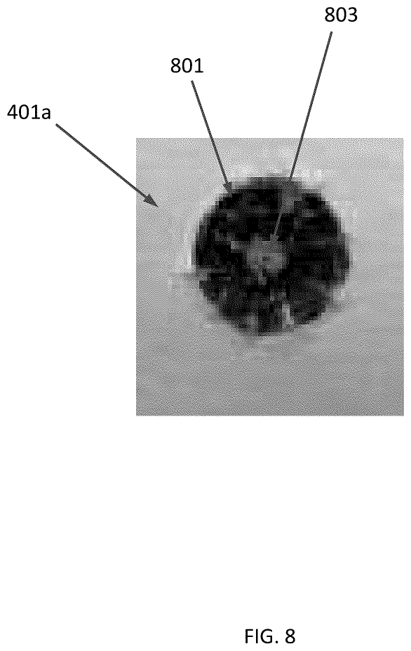

Improvement on traditional yaw cards is thus achieved by hybridizing two known materials-e.g., paper and foam as shown and described herein-to exploit the benefits of both. The paper provides a smooth surface (witness layer 401) to mark the bullet's outline (“witness hole”), and the foam gives structural support and shock absorption to the paper to prevent tearing or other destruction of the layered yaw card. In addition, by preventing immediate displacement of the witness layer, the witness layer is held in contact with the projectile, providing for a longer interaction, which provides for a cleaner, more accurate witness hole. This longer interaction is evidenced, for example, in FIGS. 7-8, where a darker color surrounding the ballistic signature (witness hole) 701, 801 on an exterior strike face 401a of the witness layer 401 indicates oxidation due to the longer interaction and wherein the shockwave-dissipating layer 703, 803 can be seen behind the witness hole 801.

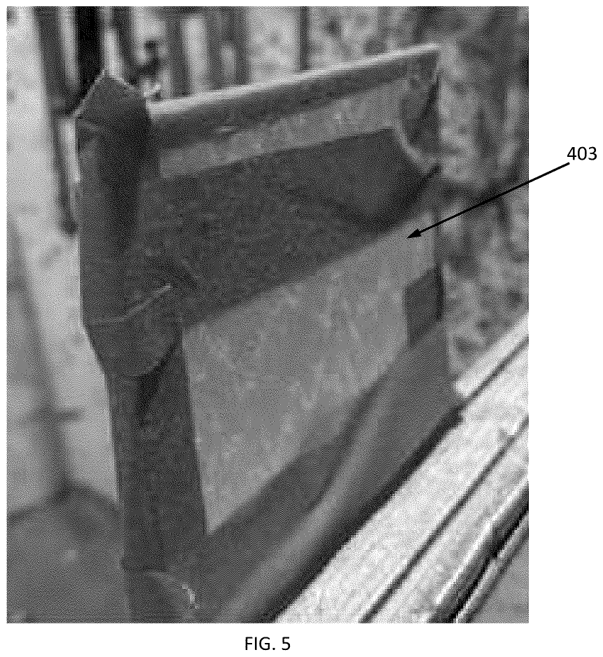

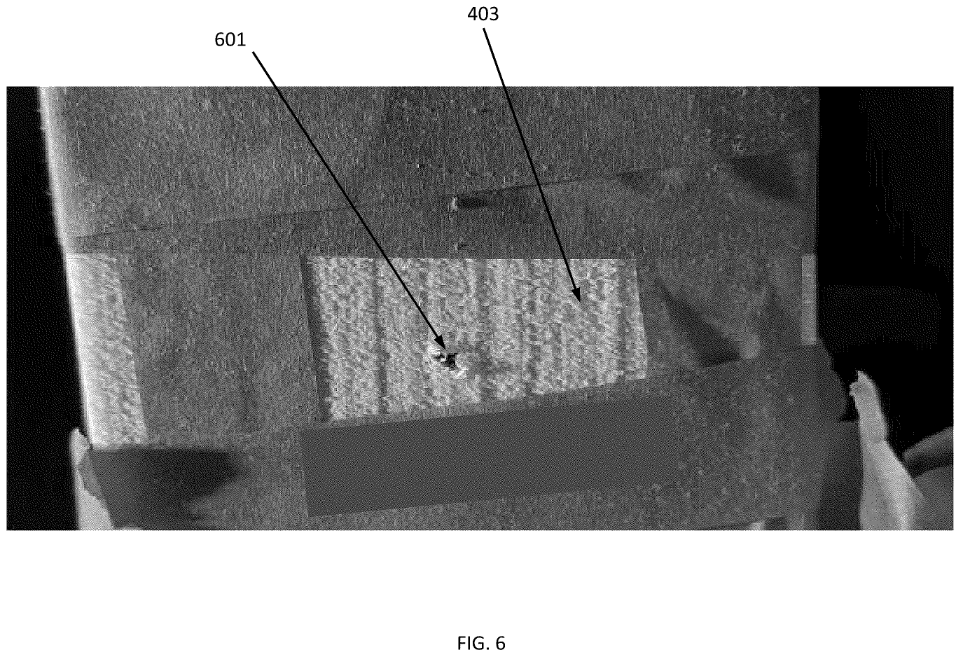

The result is a more durable yaw card 400 that can record the exact shape of the ballistic projectile's cross-section, even under the violent pressure of a passing supersonic round. In some embodiments and as shown, for example, in FIGS. 5-8 and 10-13, the layered yaw card 400 can include a witness layer 401 constructed of cardstock, and a shockwave-dissipating layer 403 constructed of a rigid or semi-rigid foam such as XPS (extruded polystyrene) attached as a backing thereto. This configuration reduces the propensity of the card stock from ripping and tearing upon impact when compared with a conventional unbacked yaw card. More generally, any suitable material can be used for the witness layer 401 and/or the shockwave-absorbing layer 403. It is noted, however, that expanded foams such as expanded polystyrene (EPS) exhibit lower performance compared to more homogenous foams such as extruded foams due to the inconsistent density and relatively low adhesion between beads.

Use of the layered yaw cards described herein is also practical for precision yaw measurement applications such as, for example, ensuring a test bullet's yaw is under 3-5° as required by body armor standards. Critically, as shown by the test results illustrated and described below, the layered yaw cards presented herein do not have a measurable effect on the trajectory or velocity of the ballistic round being used for the test.

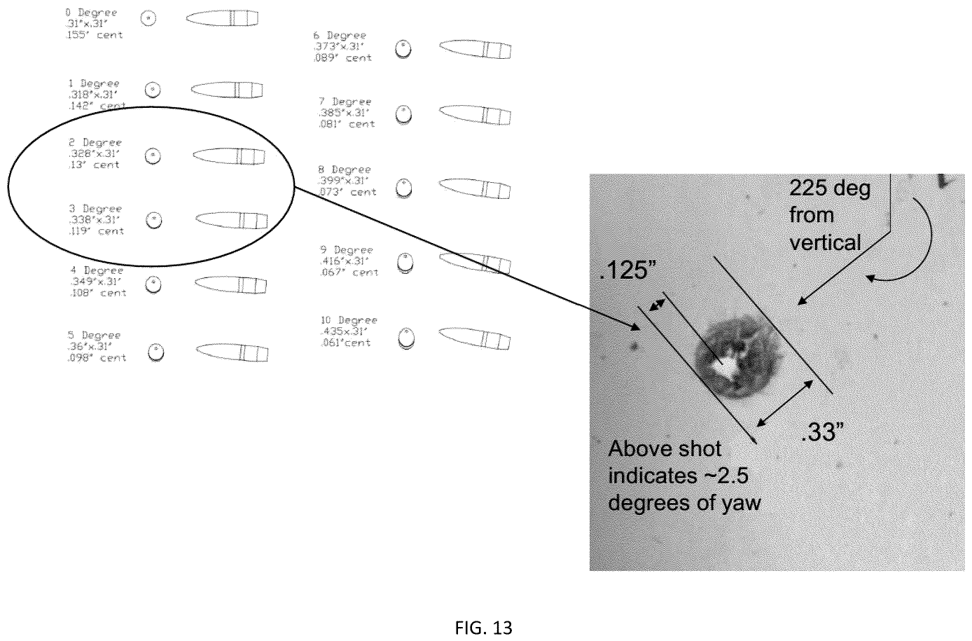

Furthermore, because of the foam backing, the layered yaw card preserves integrity of the initial penetration point in the yaw card. As such, it is possible to determine not only the yaw angle but also the orientation of yaw relative to the vertical axis of the range. This can be accomplished, as shown in FIG. 13, for example, by measuring the widest point and the center point and matching to the projected geometries of the projectile. The yaw orientation can then be estimated from a reference chart based on where the initial penetration signature is located relative to the vertical axis of the card

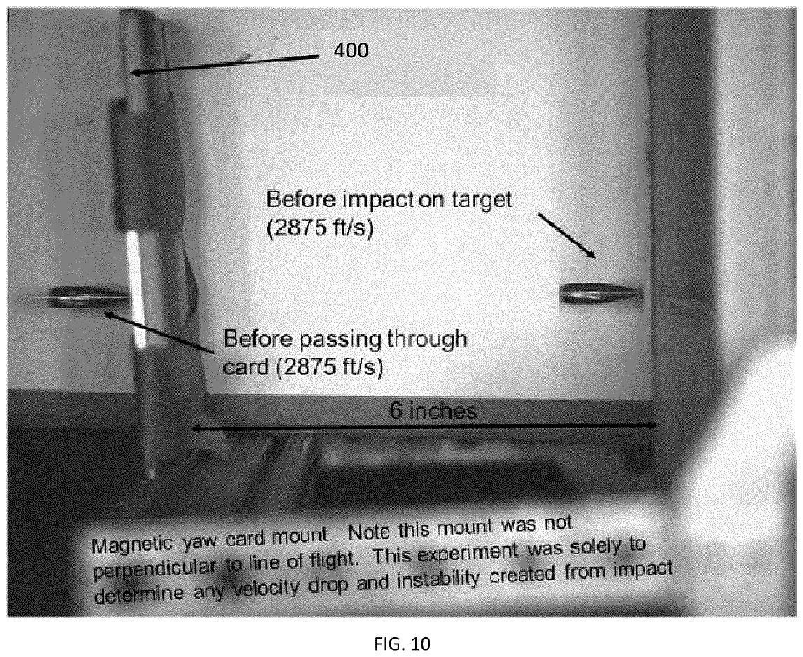

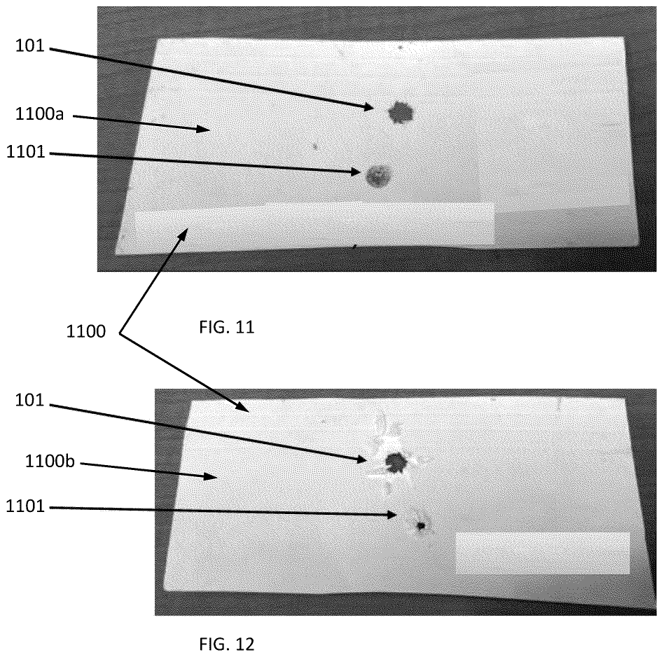

As such, the layered yaw cards provided herein advantageously improve ballistic testing, including testing of ballistic armor such as, for example, body armor, armored helmets, and/or armor plates via improved precision and accuracy with respect to yaw measurement, resulting from ensuring that the evidence (hole shape) isn't destroyed by the ballistic round during the test. In particular, by providing a laminate of paper and foam, the layered yaw cards 400 provided herein facilitate the creation of a clean witness hole of the passing bullet and preservation of the initial penetration point. This is achieved because, when the layered struck by the ballistic projectile, the foam backing absorbs the shock wave imparted by the bullet to the paper, resulting in a tear-free witness hole that is exactly shaped by the bullet's trajectory. This improvement is shown most clearly in FIGS. 11-12, which illustrate a side-by-side comparison between unbacked (unsupported) yaw card results and layered yaw card results on a single yaw card 1100 having both backed and unbacked portions. As shown, the unsupported yaw card exhibits significant distortion and tearing damage along the edge of the witness hole 101 at the strike face 1100a and, at the rear face 1100b, significant delamination and destruction. By comparison, the rear face 1100b of the layered portion of the yaw card (foam backing removed after testing) exhibits much less damage in a much more confined area and exhibits minimal tearing and distortion at the witness hole 1101.

### Software Applications

In some embodiments, a software application (e.g., a desktop software and/or a mobile application operable on a smartphone, tablet, laptop, or other mobile device) can be provided, wherein the software application is capable of processing recorded yaw card data (e.g., video, photographic, other optical data, and/or circuit data) associated with a ballistic test to determine ballistic behavior (e.g., yaw, wobble) based on the type of bullet or other ballistic projectile, geometry, and hole shape. Projectiles striking the layered yaw card with zero yaw angle (exactly perpendicular) will produce a perfectly circular witness hole in the witness layer, whereas yawed projectiles will produce oval witness holes. Generally speaking, evidence of yaw and/or wobble will be clearer and more dramatic (i.e., the hole will be more oval/elongated and less round for each degree of off-axis yaw) for longer projectiles than for shorter ones.

In embodiments where the software application is a mobile application, the app can advantageously prompt a user to simply use the mobile device to take a picture for use in analyzing the test results. As such, the app can also advantageously provide instructions to the user with respect to proper alignment of the camera with the yaw card in order to produce better results.

In some embodiments, the software application can process the yaw card data via a pixel counter analyzing visual images on a pre-populated dense point cloud. The software application can then determine a diameter of the witness hole (if circular) or can determine each of the major and minor axes of the witness hole (if elliptical). Once the dimensions of the witness hole are determined, the yaw angle of the projectile can be determined.

The integration of other features and applications of many mobile devices can also provide other advantages for capturing and analyzing video and/or optical data. For example, modern mobile devices often include features such as grid projection, digital levels, and LiDAR scanners to provide indications of distance and relative orientation between the optical/video sensor and the witness hole of the layered yaw card, which helps to ensure accurate analysis of the witness hole.

Additionally, many integrated and/or third-party software applications can provide image processing features such as magnification, edge detection, and/or color isolation.

### Analysis Aids

In some embodiments, the layered yaw cards provided herein can be colored for high contrast with a color of a photographic background associated with a video or optical system used in connection with the ballistic testing. In such embodiments, photographic/optical filters can be deployed to aid optical size and shape analysis of the witness hole. For example, in some embodiments, the yaw card can be colored pure green, and the background can be colored pure red. Then, an RGB filter can be tuned to record pure green and pure red, thereby providing a clear and highly visible hole (red) on the green field of the layered yaw card.

By providing higher contrast, filterable colors, optical and/or video analysis can be more effective, particularly when used in combination with other software and/or hardware capabilities. For example, having high contrast filterable colors can permit the use of a color isolation feature to improve contrast within the image, which, in turn, can improve clarity and results for magnification and/or edge detection application. By improving such preprocessing, the dimensional analysis can then produce better, more accurate and reliable results.

In some embodiments, the paper layer of the yaw card can include a pattern of dots (e.g., a grid of pixel-sized dots) and/or electrical circuits on the witness layer to witness the bullet trajectory by video/optical observation of missing/broken dots and/or sensing of broken circuits. Electrical circuit data can be processed by recording multimeter or oscilloscope data from each circuit and determining a location of any failed/destroyed circuits.

Physical aids to analysis can also be provided. For example, the video and/or optical sensing device (imaging device) can be mounted on a stand, tripod, or other device to hold the imaging device at a specific location and orientation with respect to the witness hole. An external level such as a laser or spirit level can also be used to confirm a level orientation between the imaging device and the witness hole.

### Velocity Test Results

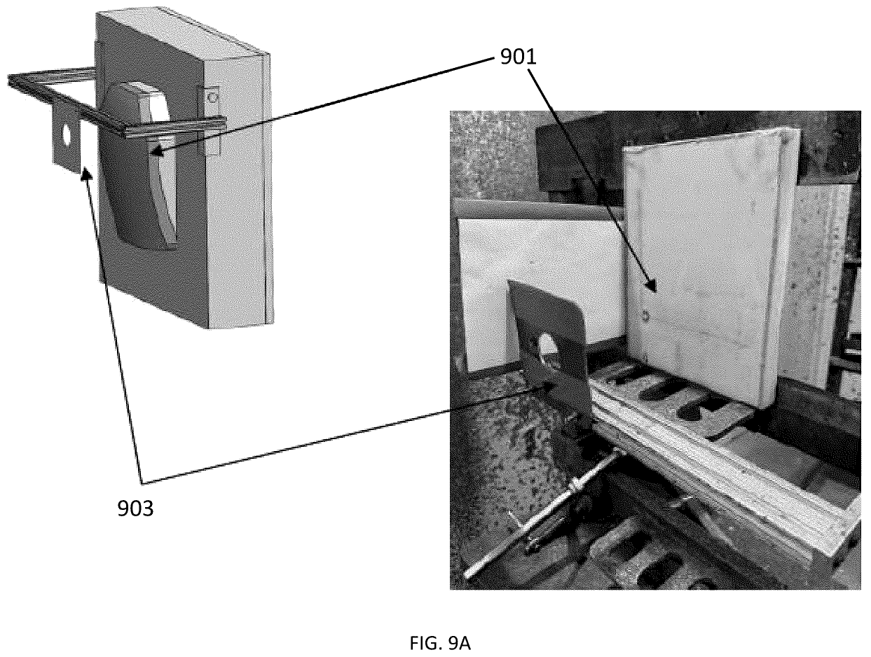

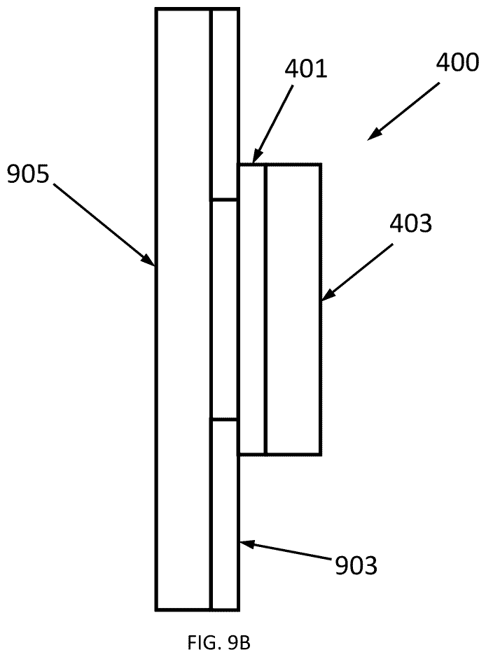

As shown in FIGS. 9A and 10, an initial proof of concept test range was set up having a yaw card mount 903, a target 901, and provided with an existing high-speed video system and corresponding video analysis software to record the pre-strike velocity before impacting the layered yaw card to be tested, as well as post-strike velocity and any yaw created from passing through the layered yaw card 400.

As shown in FIG. 10, using the video analysis software, the initial velocity of the test projectile was calibrated to a chronograph reading of 2875 ft/s. Then, after passing through the layered yaw card 400, the velocity of the test projectile was measured again, using 2 frames, to be 2875 (ft/s), thus indicating no measurable reduction in velocity after impact with the layered yaw card 400. In addition, measurement of the angle of the test projectile before impact with the layered yaw card and after impact (shown) indicated a change of 0 degrees, indicating no change in angular velocity. That is, the layered yaw card had no measurable effect on projectile velocity, no measurable effect on projectile rotation, and no measurable effect on projectile trajectory.

As shown in FIG. 9B, it is further noted that, in some ballistic testing environments, the layered yaw card may be held in or on the yaw card mount 903 preceded and/or followed by one or more break screens 905 for detecting a velocity of the projectile.

### Method for Quantifying Rotational Progression of Projectile Yaw and Predicting Impact Orientation

In some embodiments, two layered yaw cards can be used to predict impact orientation of the ballistic projectile. In particular, experimentation was conducted to determine if the rotational direction of projectile yaw can be quantified along the flight path and used to predict the projectile orientation at impact. This was accomplished by measuring yaw magnitude and orientation at two known locations using the layered yaw cards disclosed herein, and using a calculation of the resulting twist rate of yaw between the measurement points to predict impact orientation at the target.

### Test Method

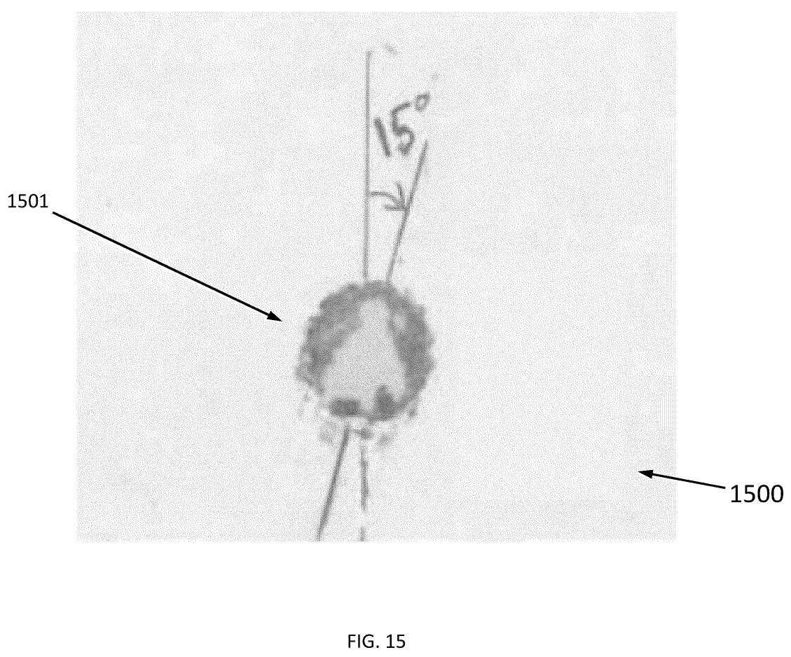

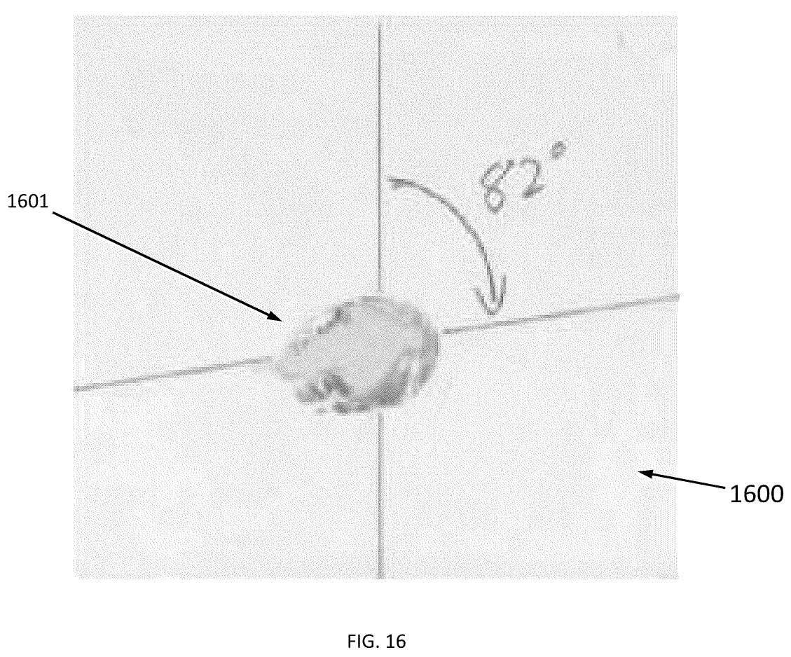

Referring now to FIGS. 15-16, two independent yaw cards 1500, 1600 were positioned along the projectile flight path at a fixed and known separation distance. Specifically, the distance between the first (uprange) yaw card 1500 and second (downrange) yaw card 1600 was 52 inches, and the distance from the second yaw card 1600 to the target surface was 76 inches. A ballistic projectile was test fired through the yaw cards 1500, 1600 and into the target. Each yaw card 1500, 1600 recorded a ballistic signature 1501, 1601 indicating the projectile's yaw magnitude and orientation at the respective measurement location.

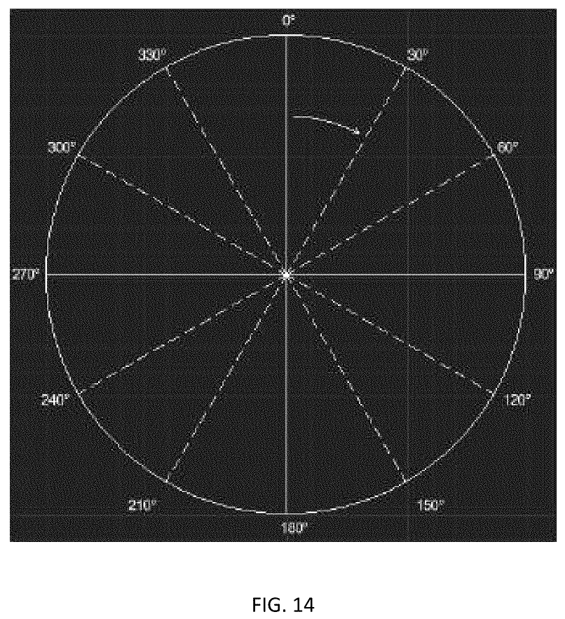

Upon inspection, both yaw cards indicated a yaw magnitude of 9°, demonstrating consistent projectile yaw amplitude at the two measurement points. However, the elliptical perforations observed in the cards showed that the projectile was oriented in different rotational directions at each location. In order to quantify this change in orientation, a reference angle was established using a vertical datum line of a reference card such as the one shown in prior art FIG. 14. Projectile orientation was then measured as a clockwise angular displacement from the reference, consistent with the direction of ballistic rotation.

Using this reference, the projectile orientation recorded at the first yaw card 1500 was 15°, while the second yaw card 1600 indicated an orientation of 82°. The difference in orientation between the two measurement points was therefore 67°. Dividing this angular change by the known separation distance between the yaw cards (52 inches) yielded a calculated yaw twist rate of approximately 1.29 degrees per inch (deg/in) (more precisely, 1.28846 deg/in), also referred to herein as the “rotational progression” of the projectile's yaw along the flight path.

### Yaw Prediction

Once the twist rate of yaw was determined, it was used to extrapolate the projectile's expected orientation at the target impact location. Using the calculated twist rate of 1.28846 deg/in and the known distance from the second yaw card to the target (76 inches), the projectile's orientation at impact was predicted. In particular, based on this calculation, the projectile orientation at the target surface was predicted to be approximately 180° (more precisely 179.92°) clockwise from the vertical reference.

### Experimental Validation

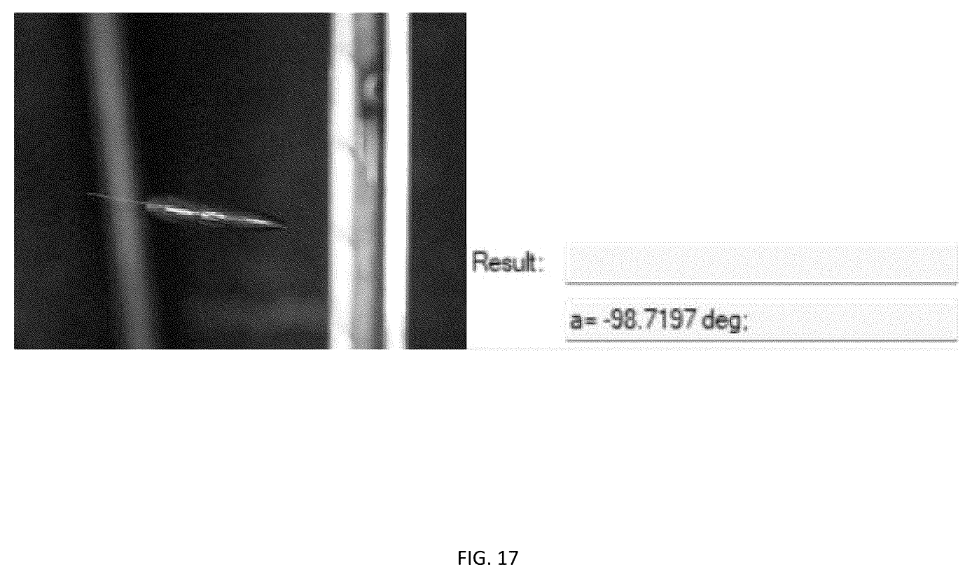

The predicted yaw orientation at impact was validated using a high-speed camera system positioned to capture the projectile immediately prior to impact as shown in FIG. 17. Analysis of the high-speed footage indicated a yaw magnitude of 8.72°, which closely agrees with the 9° yaw magnitude recorded by both yaw cards. Additionally, the projectile orientation observed in the video appeared to be approximately 180° from the vertical reference, which closely matches the predicted orientation of 179.92° derived from the twist rate calculation.

Thus, the experimental results demonstrate that projectile yaw orientation progresses in a predictable rotational manner along the flight path. By measuring yaw orientation at two known locations and calculating the resulting twist rate, the projectile's yaw direction at impact can be reliably predicted. Independent verification using high-speed video analysis confirmed both the predicted orientation and the measured yaw magnitude, demonstrating the validity of this method for characterizing and forecasting projectile yaw behavior.

While example embodiments have been particularly shown and described, it will be understood by those skilled in the art that various changes in form and details may be made therein without departing from the scope of the embodiments encompassed or contemplated herein.

As used herein, “consisting essentially of” allows the inclusion of materials or steps that do not materially affect the basic and novel characteristics of the claim. Any recitation herein of the term “comprising”, particularly in a description of components of a composition or in a description of elements of a device, can be exchanged with “consisting essentially of” or “consisting of”.

What is claimed is:

1. A layered yaw card for ballistic testing comprising:
a witness layer; and
a shockwave-dissipating layer laminated to the witness layer.

2. The layered yaw card of claim 1, wherein the witness layer is constructed of one or more of paper, cardstock, cardboard, photographic paper, or combinations thereof.

3. The layered yaw card of claim 1, wherein the shockwave-dissipating layer is constructed of a foam.

4. The layered yaw card of claim 1, further comprising a dot pattern printed on a visible surface of the witness layer.

5. The layered yaw card of claim 1, further comprising a pattern of electrical circuits formed on or in at least one of the witness layer and/or the shockwave-dissipating layer.

6. The layered yaw card of claim 1, wherein the witness layer is colored for filterable high contrast relative to an image background, wherein an optical and/or video sensor is configured to capture optical and/or video data including both the witness layer and the image background.

7. A method for determining yaw of a ballistic projectile, comprising:
interposing the layered yaw card of claim 1 between a ballistic projectile and a target such that he ballistic projectile passes through the layered yaw card to form a witness hole in the witness layer;
measuring one of a diameter of the witness hole or both a major axis and minor axis of the witness hole; and
determining, according to the measured diameter or major and minor axes, a yaw angle of the ballistic projectile.

8. The method of claim 7, further comprising measuring a maximum width of the witness hole and a distance from an edge of the witness hole to the center of the witness hole to determine both the yaw angle and an orientation of yaw of the ballistic projectile.

9. The method of claim 7, wherein the step of measuring further comprises analyzing video and/or optical data captures including the witness hole.

10. The method of claim 9, wherein the step of analyzing video and/or optical data captures includes performing one or more of:
an edge enhancement analysis of the video and/or optical data captures;
a color filtration analysis of the video and/or optical data captures;
pixel counting of the video and/or data captures with respect to a pre-populated dense point cloud; or
a combination thereof.

11. The method of claim 10, wherein the witness layer is colored for filterable high contrast relative to an image background of the video and/or optical data captures to aid the color filtration analysis and/or the edge enhancement analysis.
